(19) United States
(12) Patent Application Publication
(10) Pub. No.: US 2023/0169533 A1
(43) Pub. Date: Jun. 1, 2023

(54) PROFIT ALLOCATION DETERMINATION APPARATUS, PROFIT ALLOCATION DETERMINATION METHOD, AND PROFIT ALLOCATION DETERMINATION PROGRAM

(71) Applicant: JVCKENWOOD Corporation, Yokohama-shI (JP)

(72) Inventor: Mizuki OHARA, Yokohama-shi (JP)

(21) Appl. No.: 18/050,494

(22) Filed: Oct. 28, 2022

(30) Foreign Application Priority Data
Nov. 30, 2021 (JP) 2021-194012

(51) Int. Cl. G06Q 30/02; G06V 40/16; G06V 10/74

(52) U.S. Cl. CPC G06Q 30/0211; G06V 40/161; G06V 10/761

(57) ABSTRACT

A facial recognition unit and a sound recognition unit calculate a similarity between an object in a filmed image and an object registered in advance. A profit allocation unit determines a ratio of allocation of a profit gained from a use of the filmed image to a person holding a right to the object, based on a result of comparison between the similarity and a threshold value. When the similarity is equal to or higher than the threshold value, the profit allocation unit determines the ratio of allocation such that the higher the similarity, the higher the ratio of allocation, and, when the similarity is less than the threshold value, the profit allocation unit determines the ratio of allocation to the right holder to be zero.

### BACKGROUND OF THE INVENTION

### 1. Field of the Invention

The present invention relates to profit allocation determination technology for an image usage fee.

### 2. Description of the Related Art

Recently, imaging equipment are available in increasingly smaller sizes and exhibit increasingly higher precision. It has become possible for ordinary users to film and distribute a high-quality image by using the imaging equipment. It is also possible for users to share and distribute an image casually by using a social networking service (SNS). In this background, permission may be given to filming from a spectator's seat at a site of a live music concert or a drama in the future, allowing an image filmed by ordinary spectators to be distributed or sold/bought over the Internet.

Patent literature 1 discloses registering faces of and profile information on famous people in a database, extracting a famous person whose face is similar to the face of a filming user, and providing information accordingly.
[Patent literature 1] JP2005-242433

When the face of an artist or an actor/actress is captured in a filmed image, the filming person is required to obtain a permission to use the filmed image from the filmed person because the filmed person owns the right of publicity. If a permission is not obtained, the filming person is required to make it impossible to recognize the face by, for example, blurring the face. Even if the filmed person grants a permission to use the filmed image, the filmed person does not generally benefit from profit allocation. The filmed person requesting profit allocation needs to negotiate with the filming person to determine a profit allocation ratio. Further, a filmed image may include an object protected by a certain right other than the right of publicity, and it is desirable to allocate the profit to a person holding the right to the object.

### SUMMARY OF THE INVENTION

The present invention addresses the above-described issue, and a purpose thereof is to provide a profit allocation determination technology capable of allocating a profit from an image usage fee to a right holder.

A profit allocation determination apparatus according to an embodiment of the present invention includes: a recognition unit that calculates a similarity between an object in a filmed image and an object registered in advance; and a profit allocation unit that determines a ratio of allocation of a profit gained from a use of the filmed image to a person related to the object, based on a result of comparison between the similarity and a threshold value.

Another embodiment of the present invention relates to a profit allocation determination method. The method includes: calculating a similarity between an object in a filmed image and an object registered in advance; and determining a ratio of allocation of a profit gained from a use of the filmed image to a person related to the object, based on a result of comparison between the similarity and a threshold value.

Optional combinations of the aforementioned constituting elements, and implementations of the disclosure in the form of methods, apparatuses, systems, recording mediums, and computer programs may also be practiced as additional modes of the present invention.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 shows a configuration of an image selling and buying apparatus according to an embodiment;

FIG. 2 illustrates a method of determining a ratio of allocation by the profit allocation unit FIG. 1; and

FIG. 3 is a flowchart illustrating a procedure for allocation of a profit by the image selling and buying apparatus of FIG. 1.

### DETAILED DESCRIPTION OF THE INVENTION

The invention will now be described by reference to the preferred embodiments. This does not intend to limit the scope of the present invention, but to exemplify the invention.

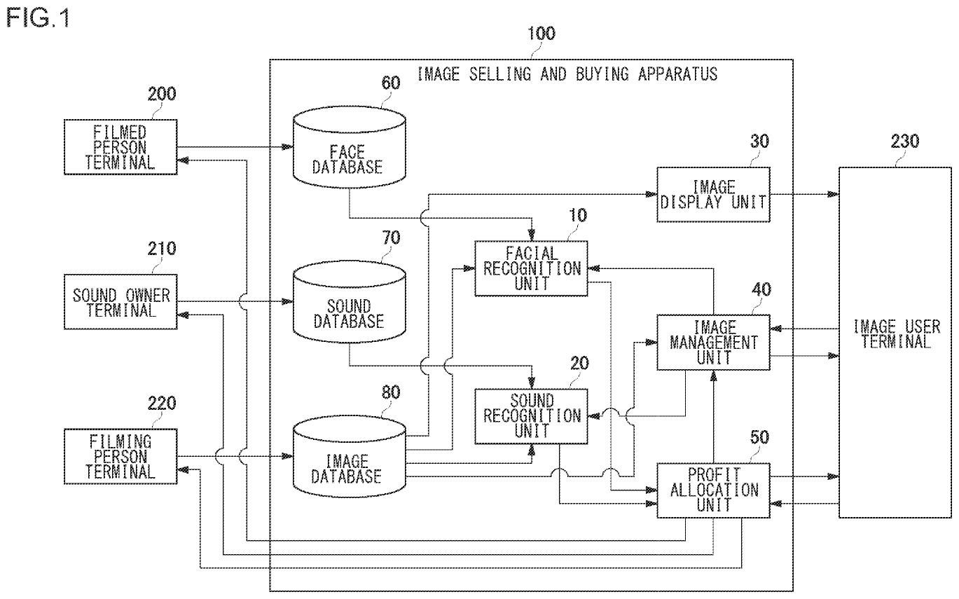

FIG. 1 shows a configuration of an image selling and buying apparatus 100 according to an embodiment. The image selling and buying apparatus 100 is one example of a profit allocation determination apparatus. In this case, an image is taken as an example, and a description is given of a technology of determining allocation of a profit from an image usage fee. However, any object other than the face of a filmed person (e.g., a painting, photo, music, logo, building, etc.) is applicable so long as the object is protected by a certain right. In the description of the embodiment, the face of the filmed person corresponds to the object, and the filmed person is related to the object. The technology described herein can be applied to allocation of a profit from the usage fee of arbitrary objects as listed above.

The image is inclusive of graphical content and sound. When an image is filmed at a site of a live music concert or a drama, the filmed image captures a filmed person such as an artist and an actor/actress. Also, sound such as a song, dialog, instrumental sound, etc. is recorded.

The image selling and buying apparatus 100 includes a facial recognition unit 10, a sound recognition unit 20, an image display unit 30, an image management unit 40, a profit allocation unit 50, a face database 60, a sound database 70, and an image database 80.

Filmed images may be managed in distributed management as non-fungible tokens (NFT) on a block chain instead of being managed by a database in centralized management. NFT functions as digital data for filmed images with a certificate of ownership.

A filmed person terminal 200, a sound owner terminal 210, a filming person terminal 220, and an image user terminal 230 are connected to the image selling and buying apparatus 100 via a network. The image selling and buying apparatus 100 includes a network interface and exchanges various information with the filmed person terminal 200, the sound owner terminal 210, the filming person terminal 220, and the image user terminal 230 via the network interface. In the description of the embodiment, the network interface will be omitted.

The filmed person registers his or her facial data in the face database 60 from the filmed person terminal 200. The sound owner registers sound data such as a song and music in the sound database 70 from the sound owner terminal 210. The filming person registers the image that he or she filmed in the image database 80 from the filming person terminal 220.

The image display unit 30 displays a simplified version of the filmed image registered in the image database 80 on the image user terminal 230. The simplified version is a portion of the filmed image and is inclusive of a thumbnail and a preview. The complete version of the filmed image is not displayed until the image user pays the image usage fee.

The image user selects a filmed image from the image user terminal 230 and sends a request to use the selected filmed image to the image selling and buying apparatus 100. In this process, the image user terminal 230 transmits a usage request including an image number for identifying the selected filmed image to the image management unit 40.

The image management unit 40 receives the usage request including the image number for identifying the filmed image selected by the image user from the image user terminal 230. The image management unit 40 supplies the image number of the filmed image selected by the image user to the facial recognition unit 10 and the sound recognition unit 20.

The facial recognition unit 10 reads the filmed image selected by the image user from the image database 80 based on the image number included in the usage request, recognizes the face of the filmed person captured in the filmed image, checks the face of the filmed person thus recognized against facial data for a person registered in the face database 60 in advance, and calculates a similarity between the face of the filmed person thus recognized and the face of the person registered in advance.

The sound recognition unit 20 reads the filmed image selected by the image user from the image database 80 based on the image number of the filmed image selected by the image user, recognizes the sound recorded in the filmed image, checks the recognized sound against the sound of a sound owner registered in the sound database 70, and calculates a similarity between the recognized sound and the sound of the sound owner registered in advance.

For facial recognition and sound recognition, an artificial intelligence (AI) technology such as deep learning may be used.

Generally, AI-based facial recognition offers nearly 100% recognition rate in the case of the identical person. In the case of strangers, on the other hand, the recognition rate is nearly 0%. In this background, the facial recognition unit 10 provides a detection threshold value of, for example, 90% for the facial recognition rate and determines that the face is detected when the facial recognition rate exceeds the detection threshold value. In this way, the facial recognition unit 10 outputs a person associated with a face for which the similarity is 90% or higher, along with the similarity. Further, when two or more faces having a similarity of 90% or higher are identified as matching one face within the same frame, the facial recognition unit 10 may output a person associated with a face showing a higher similarity, along with the similarity. Alternatively, the facial recognition unit 10 may display all or multiple high-ranking faces with a similarity of 90% or higher on the display screen of the image selling and buying apparatus 100 to allow manual selection of one of the faces. The same is true of AI-based sound recognition. The sound recognition unit 20 provides a detection threshold value. When the sound recognition rate exceeds the detection threshold value, the sound recognition unit 20 determines that the sound is detected.

The profit allocation unit 50 determines a ratio of allocation of the profit gained from the use of the filmed image to the filmed person and the sound owner in accordance with the similarities calculated by the facial recognition unit 10 and the sound recognition unit 20, respectively.

The profit allocation unit 50 presents the usage fee of the filmed image selected by the image user to the image user at the image user terminal 230. The profit allocation unit 50 receives the payment of the usage fee of the filmed image selected by the image user from the image user at the image user terminal 230. The profit allocation unit 50 notifies the image management unit 40 of the completion of payment of the usage fee of the filmed image selected by the image user.

The image management unit 40 transmits the data for the filmed image selected by the image user to the image user terminal 230. The image user at the image user terminal 230 can view the filmed image selected by the image user.

The profit allocation unit 50 allocates the profit that remains from deducing the service charge from the usage fee of the filmed image paid by the image user between the filming person, the filmed person, and the sound owner, based on the ratio of allocation to the filmed person and the sound owner. The profit allocation unit 50 provides the allocated profit to the filming person terminal 220, the filmed person terminal 200, and the sound owner terminal 210 as the reward.

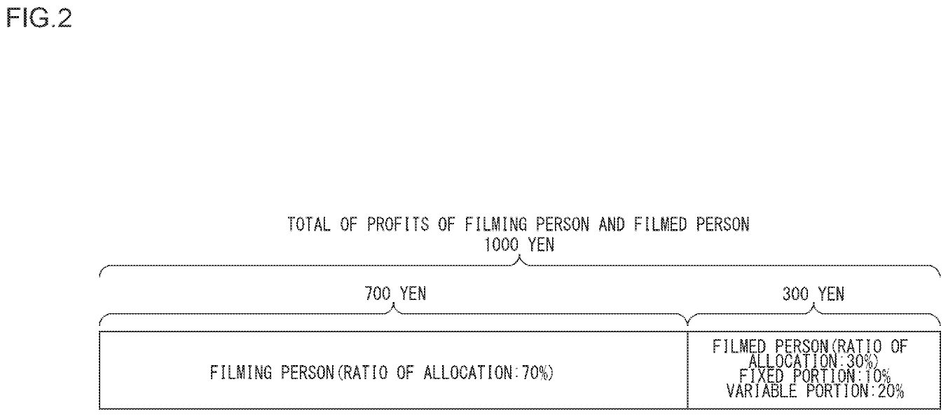

FIG. 2 illustrates a method of determining a ratio of allocation by the profit allocation unit 50 FIG. 1.

The profit allocation unit 50 determines the ratio of allocation of the profit gained from the user of the filmed image to the filmed person and the sound owner, based on a result of comparing the similarities calculated by the facial recognition unit 10 and the sound recognition unit 20, respectively, with the detection threshold value.

The case of facial recognition will be discussed here as an example. It is assumed that the detection threshold value of facial recognition is 90%. It is further assumed that, of the total profit gained from the use of the filmed image, 50% will be the reward for the filming person and the filmed person.

Given that the total profit of the filmed image is 2000 yen, 1000 yen, i.e., 50%, will be the reward for the filming person and the filmed person, as shown in FIG. 2. It is assumed here that the profit is allocated between the filming person and the filmed person such that the filming person takes 70% and the filmed person takes 30%.

The profit of the filmed person is comprised of a fixed portion gained without exception when the face is recognized and a variable portion that varies depending on the facial recognition rate (similarity between the faces). In this case, the case with the fixed portion of 10% and the variable portion of 20% is shown as an example.

The variable portion of the profit of the filmed person varies depending on the difference between the facial recognition rate and the detection threshold value of facial recognition.

When the facial recognition rate is 100%, the difference from the detection threshold value 90% is 10%. The filmed person can gain 200 yen, i.e., the entirety of the variable portion of 20% of the profit of the filmed person. Including the fixed portion of 100 yen, the profit of the filmed person amounts to 300 yen, and the profit of the filming person will be 700 yen.

When the facial recognition rate is 95%, the difference from the detection threshold value 90% is 5%. The filmed person can gain 100 yen, i.e., half the variable portion of 20% of the profit of the filmed person. Including the fixed portion of 100 yen, the profit of the filmed person amounts to 200 yen. The profit of the filming person will be 800 yen because of the addition of the variable portion subtracted from the profit of the filmed person.

When the facial recognition rate is 90%, the difference from the detection threshold value 90% is 0% so that the facial recognition rate and the detection threshold value are identical. Thus, the variable portion of the profit of the filmed person is 0 yen, and the profit of the filmed person is comprised only of the fixed portion of 100 yen. The profit of the filming person will be 900 yen because of the addition of the variable portion subtracted from the profit of the filmed person.

When the facial recognition rate is less than 90%, it is determined that a registered face is not detected. The profit of the filmed person will be 0 yen, and the profit of the filming person will be 1000 yen.

Thus, when the facial recognition rate (similarity between the faces) is equal to or higher than the detection threshold value, the profit allocation unit 50 determines the ratio of allocation such that the higher the facial recognition rate, the higher the ratio of allocation of the profit to the filmed person. When the facial recognition rate is less than the threshold value, the profit allocation unit 50 determines the ratio of allocation of the profit to the filmed person to be zero.

The facial recognition unit 10 may calculate a spatial proportion, which is a proportion of an area occupied by the face of the filmed person in the filmed image, or a temporal proportion, which is a proportion of a time including the face of the filmed person. The profit allocation unit 50 may determine the ratio of allocation of the profit to the filmed person based further on the spatial proportion or the temporal proportion in addition to the result of comparison between the facial recognition rate and the detection threshold value.

For example, the facial recognition unit 10 may calculate, in addition to a similarity between the faces, the spatial proportion such as the size/resolution of the face of the filmed person captured in the filmed image and the effective size of the face identified when the face of the filmed person is in the shadows or calculate the temporal proportion such as the time/number of frames in which the face of the filmed person is captured. The facial recognition unit 10 may adjust the ratio of allocation such that the larger the spatial proportion/temporal proportion thus calculated, the larger the ratio of allocation.

The same is true of sound recognition. When the sound recognition rate (similarity between the sounds) is equal to or higher than a threshold value, the profit allocation unit 50 determines the ratio of allocation such that the higher the sound recognition rate (similarity between the sounds), the higher the ratio of allocation of the profit to the sound owner. When the sound recognition rate (similarity between the sounds) is less than the threshold value, the profit allocation unit 50 determines the ratio of allocation of the profit to the sound owner to be zero.

The sound recognition unit 20 may further calculate a spatial proportion, which is a proportion including person information indicating the sound of the sound owner in the sound recorded in the filmed image or a temporal proportion, which is a proportion of a time including person information on the sound of the sound owner. The profit allocation unit 50 may determine the ratio of allocation of the profit to the sound owner based further on the spatial proportion or the temporal proportion in addition to the result of comparison between the sound recognition rate (similarity between the sounds) and the detection threshold value.

For example, the sound recognition unit 20 may calculate, in addition to a similarity between the sounds, a spatial proportion such as the quality/sound volume of the sound recorded in the filmed image and an effective proportion of that sound mixed with the other sound or calculate a temporal proportion such as the time/number of frames in which the sound of the sound owner is recorded effectively. The sound recognition unit 20 may adjust the ratio of allocation such that the larger the spatial proportion/temporal proportion thus calculated, the larger the ratio of allocation.

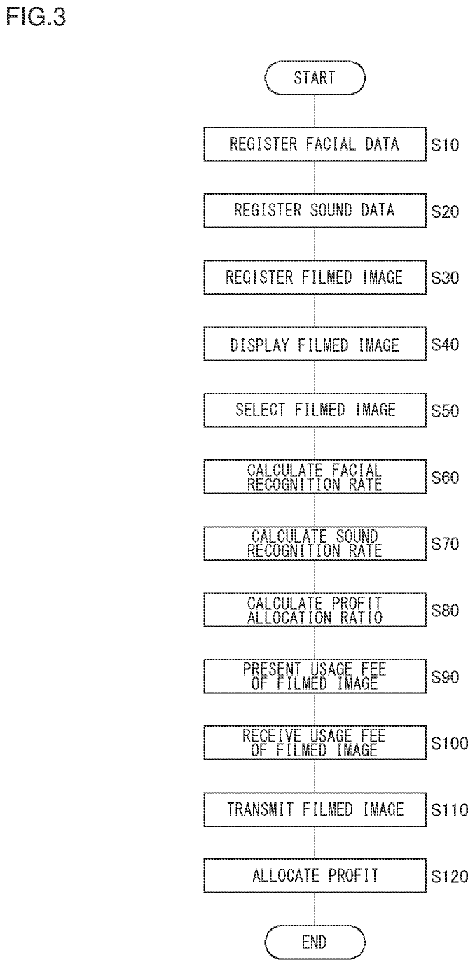

FIG. 3 is a flowchart illustrating a procedure for allocation of a profit by the image selling and buying apparatus 100 of FIG. 1.

The filmed person terminal 200 is used to register facial data input from the filmed person in the face database 60 (S10). The sound owner terminal 210 is used to register sound data input from the sound owner in the sound database 70 (S20). The filming person terminal 220 is used to register the filmed image input from the filming person in the image database 80 (S30).

The image display unit 30 displays a filmed image (simplified version of the image) registered in the image database 80 on the image user terminal 230 (S40). The image user selects the filmed image in the image user terminal 230, and the image management unit 40 receives the image number identifying the filmed image selected by the image user from the image user terminal 230 (S50).

The facial recognition unit 10 calculates the facial recognition rate in the selected filmed image (S60). The sound recognition unit 20 calculates the sound recognition rate in the sound recorded in the selected filmed image (S70).

The profit allocation unit 50 identifies the filmed person in accordance with the facial recognition rate and identifies the sound owner in accordance with the sound recognition rate. The profit allocation unit 50 calculates the ratio of allocation of the profit to the filmed person and the sound owner thus identified (S80).

The profit allocation unit 50 presents the usage fee of the selected filmed image to the image user at the image user terminal 230 (S90). The profit allocation unit 50 receives the payment of the usage fee of the filmed image from the image user (S100). The image management unit 40 transmits the data for the selected filmed image to the image user (S110).

The profit allocation unit 50 allocates the profit that remains from deducting the service charge from the usage fee of the selected filmed image between the filming person, the filmed person, and the sound owner (S120).

The above-described various processes in the image selling and buying apparatus 100 can of course be implemented by hardware-based apparatus such as a CPU and a memory and can also be implemented by firmware stored in a read-only memory (ROM), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

As described above, the image selling and buying apparatus 100 of the embodiment makes it possible to allocate the profit from the image usage fee to the filmed person in accordance with the facial recognition result. The filmed person can gain a portion of the profit from the image capturing the filmed person, by registering his or her face in advance. In particular, those in the entertainment industry may positively promote the use of images that capture them to gain a proper profit as well as increasing their exposure.

The use of facial recognition makes it possible to determine the profit allocation ratio automatically in accordance with the degree of impact on the right of publicity and so makes it unnecessary for the filmed person to negotiate with the filming person for the fee. The embodiment can prevent profit allocation that is not advantageous to either side. For example, the embodiment prevents the profit of the filmed person from being too little despite the fact that the filmed person is clearly captured in the image or prevents the profit of the filming person from being too little despite the fact that the filmed persons is captured in the image only slightly.

The embodiment also makes it possible to allocate the profit to the right holder properly even in the case of an object such as sound protected by a certain right other than the right of publicity.

Described above is an explanation based on an exemplary embodiment. The embodiment is intended to be illustrative only and it will be understood by those skilled in the art that various modifications to combinations of constituting elements and processes are possible and that such modifications are also within the scope of the present invention.

What is claimed is:

1. A profit allocation determination apparatus comprising:
a recognition unit that calculates a similarity between an object in a filmed image and an object registered in advance; and
a profit allocation unit that determines a ratio of allocation of a profit gained from a use of the filmed image to a person related to the object, based on a result of comparison between the similarity and a threshold value.

2. The profit allocation determination apparatus according to claim 1, wherein
the person related to the object is a right holder related to the object.

3. The profit allocation determination apparatus according to claim 1, wherein
the object is a face of a filmed person who is filmed, and the person related to the object is the filmed person.

4. The profit allocation determination apparatus according to claim 1, wherein
when the similarity is equal to or higher than the threshold value, the profit allocation unit determines the ratio of allocation such that the higher the similarity, the higher the ratio of allocation, and, when the similarity is less than the threshold value, the profit allocation unit determines the ratio of allocation to the person related to the object to be zero.

5. The profit allocation determination apparatus according to claim 1, wherein
the recognition unit further calculates a spatial proportion, which is a proportion of an area occupied by the object in the filmed image, and
the profit allocation unit determines the ratio of allocation to the person related to the object based further on the spatial proportion in addition to the result of comparison.

6. The profit allocation determination apparatus according to claim 1, wherein
the recognition further calculates a temporal proportion, which is a proportion of a time in the filmed image that includes the object, and
the profit allocation unit determines the ratio of allocation to the person related to the object based further on the temporal proportion in addition to the result of comparison.

7. A profit allocation determination method comprising:
calculating a similarity between an object in a filmed image and an object registered in advance; and
determining a ratio of allocation of a profit gained from a use of the filmed image to a person related to the object, based on a result of comparison between the similarity and a threshold value.

8. A profit allocation determination program comprising computer-implemented modules that include:
a module that calculates a similarity between an object in a filmed image and an object registered in advance; and
a module that determines a ratio of allocation of a profit gained from a use of the filmed image to a person related to the object, based on a result of comparison between the similarity and a threshold value.
